(19) United States
(12) Patent Application Publication
(10) Pub. No.: US 2006/0180420 A1
(43) Pub. Date: Aug. 17, 2006

(54) Vibration dampers

(76) Inventors: Jem A. Rongong, Stockport (GB); Thomas Cecil, Dinan (GB); David S. Webster, Rotherham (GB)

Correspondence Address: MANELLI DENISON & SELTER, 2000 M STREET NW SUITE 700, WASHINGTON, DC, 20036-3307, US

(21) Appl. No.: 11/402,898

(22) Filed: Apr. 13, 2006

Related U.S. Application Data
(63) Continuation of application No. PCT/GB04/04175, filed on Oct. 1, 2004.

(30) Foreign Application Priority Data
Nov. 1, 2003 (GB) 0325534.6

(51) Int. Cl. F16F 7/10

(52) U.S. Cl. 188/378; 188/381

(57) ABSTRACT

A particle vibration damper includes a container which locates a plurality of steel particles. A copper winding is provided around the container to induce a magnetic field therein to increase the inter-particle pressure. By adjusting the voltage across the winding the amplitude of peak damping ability can be varied to match the vibration amplitude being damped.

This invention relates to particle vibration dampers, and also a method of damping vibrations.

A combustion chamber of a gas turbine engine comprises a combustor chamber, a transition duct and an annular distribution chamber. The transition duct transmits hot gasses from the combustion chamber to the annular distribution chamber, the hot gasses then proceed into a turbine stage thereby driving the turbine.

In order to meet NOx (oxides of Nitrogen) and CO (Carbon Monoxide) emission level requirements, turbulence of a fuel and air mixture is promoted to give acceptable combustion emissions. However, increasing the turbulence during the combustion process, to reduce emission levels, causes an increase of combustor noise which leads to an increase in vibratory stresses in the combustor system components. Combustor system components are vulnerable to high cyclic fatigue failure when the natural frequency of the component coincides or is close to coinciding with the acoustic frequency of the combustion process causing resonance of the component and consequently high vibratory amplitudes and hence high stresses in the component.

During a machining operation, for instance milling a metallic component, it is common for chatter to occur if the tooling or workpiece are of insufficient rigidity. Chatter is the vibration of the milling tool relative to the workpiece which results in either a reduction in the quality of the surface finish being machined or an increase in the machining process time where a better surface finish is required. In the manufacture, for instance, of aero-engine blisks this is of particular importance as the tough nature of the material, titanium, to be machined and the flexibility and low inherent damping of the workpiece severely curtails machining rates.

Particle vibration dampers for damping vibrations of vibrating structures may be temporarily or permanently disposed to regular or irregular workpiece and tooling geometries and may operate in extreme environmental conditions and used where access is limited and which has a reduced weight penalty.

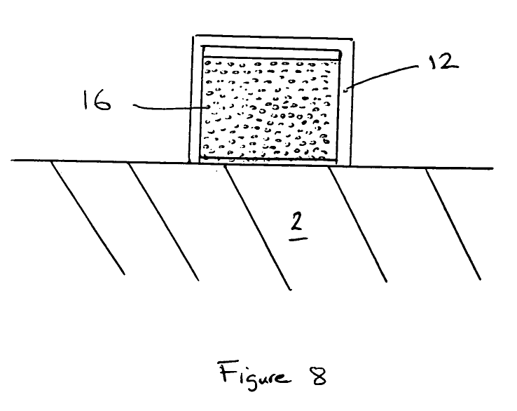

Particle vibration dampers comprise a chamber filled with particles. The chamber is mounted on or within the vibrating structure and does not form a link, or part of a link, between the vibrating structure and an adjacent support. The present invention is concerned with this form of damper. FIG. 8 depicts a typical location of a particle vibration damper. The present invention is not directed towards other forms of dampers, that may contain particles, that form a link, or part of a link, between a first vibrating component and a second supporting component.The dampers can be used to reduce vibration amplitudes in many applications. Such applications include pipe work, shell-type structures, and during machining operations to alleviate noise and chatter.

Particle vibration dampers operate by particle interface contact friction whereby the frictional forces are dependent upon material type and contact forces, the contact forces being governed by the vibratory accelerations of the wall or the chamber. Under specific vibrations a particle will attempt to migrate from one face of the particle vibration damper device to the opposite face in a direction generally parallel to the polar axis, and return, each particle competing with the other particles for their migratory position. Three analogous phases of particle movement may be identified, solid, liquid and gas, each phase appears to be dependent on the volume fill of the chamber with particles. The gas phase can only occur if the particles can behave like molecules in a gas which requires that the volume fill is well below 95%. The fluid phase of motion is where the particles ‘fluidise’ and the motion of the particles is similar to a viscous liquid, at least one free surface is required. The solid phase is where the particles migrate around the chamber without colliding or fluidising and requires almost a full volume fill. It is believed that the most effective damping region is the boundary between the solid and fluid phase, around 95% volume fill of the chamber with particles. It is believed that vibratory energy is dissipated by the inter-particle frictional forces thus providing damping to vibrations.

Although vibrating structures having chambers with a particle volume fill will reduce the vibrations of a vibrating structure to a limited extent it is particularly beneficial to have a particle volume fill greater than or equal to 95% but less than 100%. However, it is believed that for certain greater particle sizes a particle volume fill of 90% or greater may be sufficient to promote the necessary fluidised particle behaviour. This percentage fill range is particularly important in that the particles behave analogous to a fluid or solid phase rather than in an analogous gas phase.

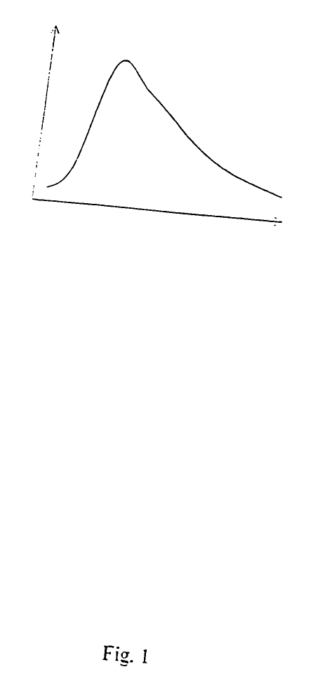

The performance of a particle vibration damper depends largely on the amplitude of vibration, specifically the ratio between vibration amplitude induced dynamic forces and steady state body forces such as gravity or rotation induced loads. Accordingly, with particle vibration dampers it is a requirement to match the peak damping ability with the amplitude it is required to operate at. FIG. 1 indicates in a graph of damping (Y-axis) against amplitude (X-axis), the typical performance of a particle vibration damper showing a clear peak damping ability at a particular amplitude. Therefore, specific designs are generally required for each particular application.

Advantageously, the performance of particle vibration dampers is relatively insensitive to frequency and temperature, thus allowing them to be used in hot environments and where a very broad range could exclude technologies such as viscoelastics that can be damaged at high or low temperatures. However, where the particle vibration dampers are to be used on a vibrating component that is subject to a wide temperature range it has been found that differences in the thermal expansion of the damper body and the particles can lead to the damper moving from the point of peak vibratory damping ability. Therefore, a damper which provides good damping ability at a first temperature may not be able to provide an adequate damping ability at the second temperature. One vibrating component that is subject to a wide temperature range is a gas turbine combustion chamber that may experience temperatures between 300K and 1400K. Other components within a gas turbine engine experience large temperature ranges.

According to the present invention there is provided a particle vibration damper for damping the vibrations of a vibratory component, the damper including a body which defines a chamber in the interior thereof, a plurality of particles located in the chamber to a volume fill in excess of 90%, characterised in that the body also includes adjustment means for adjusting the inter-particle pressure and/or inter-particle forces of said particles to maintain the peak damping ability of the damper at the amplitude of the vibrations of the vibratory component.

The adjustment means may produce an oscillating inter-particle pressure and/or inter-particle force.

The particles may be magnetic and the adjustment means may include magnetic means for inducing a magnetic field in the chamber. The magnetic means may include a coil extending around the chamber through which an electric current can be passed to provide the required magnetic field. The voltage across the coil may oscillate, and may oscillate at a frequency of less than 10 Hz.

Alternatively the magnetic means may include a magnet located in the chamber, which magnet may be a permanent magnet or an adjustable electro magnet.

The adjustment means may include a member of variable size located in the chamber to enable adjustment of the inter-particle pressure. The variable size member may be in the form of an inflatable member, with means for selectively supplying a required amount of fluid into the inflatable member.

The adjustment means may include means for adjusting the size of the chamber. The size adjustment means may include a divider extending across the interior of the body, and means for selectively moving the divider within the body.

The adjustment means may include means for passing a fluid through the chamber, and the fluid may be air. The fluid passing means may be arranged to provide an upward flow of fluid.

The invention also provides a method of damping vibrations, the method including providing a particle damper with a plurality of particles within a chamber, wherein the chamber is filled with the particles to a volume fill in excess of 90%; characterised in that the method also includes adjusting the peak damping ability of the damper to substantially correspond to the amplitude of the vibrations.

Embodiments of the present invention will now be described by way of example only and with reference to the accompanying drawings, in which:

FIG. 1 is a graph showing the damping effect relative to amplitude of a typical particle vibration damper;

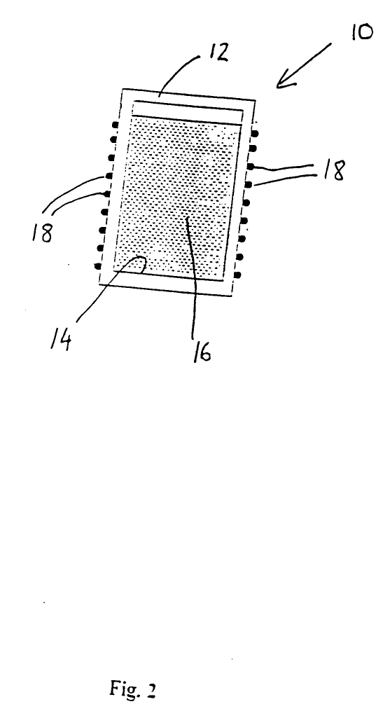

FIG. 2 is a cross sectional side view of a first friction particle vibration damper according to the invention;

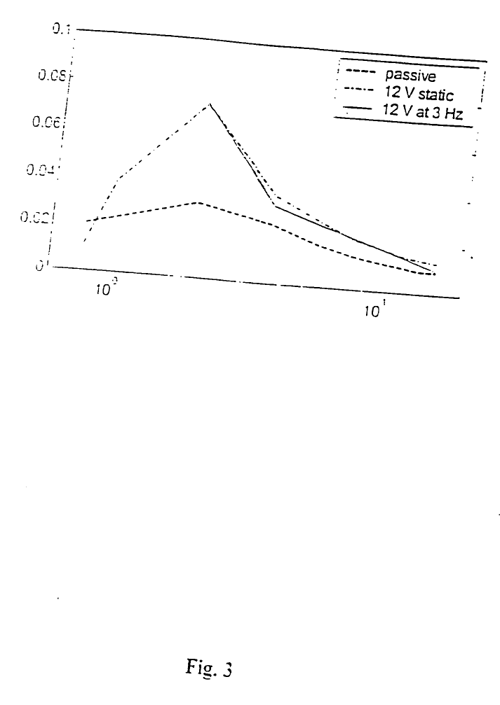

FIG. 3 is a similar graph to that shown in FIG. 1 illustrating operation of the damper of FIG. 2;

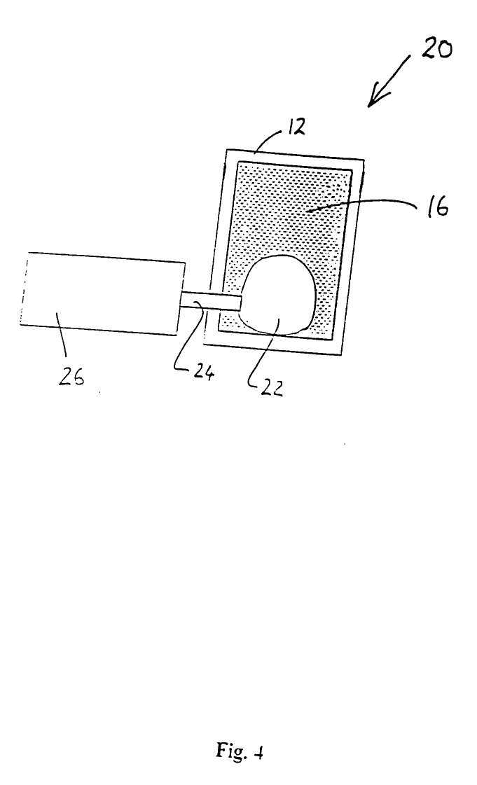

FIG. 4 to 7 are respectively similar views to FIG. 2, of second, third, fourth, and fifth friction particle vibration dampers according to the invention.

FIG. 8 is a cross-sectional side view of a particle vibration damper mounted to a vibrating component.

A particle vibration damper is mounted to a vibrating component 2 as shown in FIG. 8. The particle vibration damper comprises a container 12 containing a particulate material 16.

FIG. 2 shows a first friction particle vibration damper in the form of a particle vibration damper with a hollow cylindrical plastics material container 12 defining an internal chamber 14. The container 12 is approximately 80 mm long and 25 mm diameter, with 3 mm thick walls. The chamber 14 is filled to approximately 95% of its volume with 0.8 mm diameter steel particles 16. An enamelled copper wire 18 of 0.28 mm diameter is wound around the side of the container 12 with approximately 500 turns. The wire 18 is connected to an electricity source of variable voltage.

In use, an electric current is supplied to the wire 18 to induce a magnetic field within the chamber 14 which increases the inter-particle pressure of the steel particles 16. The voltage across the wire 18 can be altered to control the level of damping to seek peak damping ability as shown for example in the graph in FIG. 1. The voltage may be static or could be oscillated with a low frequency of less than 10 Hz. Typically, a static or very low frequency force will increase performance at the higher vibration levels. A medium frequency oscillating pressure such as 0.1 to 0.5 of the minimum operating frequency will help the particles fluidise thereby reducing the pressure. This will improve damping at very low amplitude levels.

FIG. 3 illustrates the damping provided by the damper 10, with the modal loss factor (Y-axis) against the amplitude (X-axis) with gravity as the unit. The regularly broken line shows the performance without any electric current. The line with alternate dots and dashes shows the performance with a 12 volt static voltage, whilst the solid line shows the performance with a 12 volt voltage at a 3Hz oscillation. This illustrates the significantly improved damping over a limited amplitude range. Accordingly, by altering the voltage, the amplitude range of improved damping can be varied.

FIG. 4 shows a second particle vibration damper 20 again with a plastics material container 12 in which a plurality of particles 16 are located. Also located in the container 12 is a flexible inflatable member 22 connected by a pipe 24 to a controllable air compressor 26. The inflatable member 22 can be inflated to a required size with air to increase the inter particle pressure, with the amount of pressure being chosen to provide peak damping at a required amplitude. As an alternative to air, a further fluid which may be a liquid could be used to fill the member 22. There is no requirement in this arrangement for the particles 16 to be magnetic.

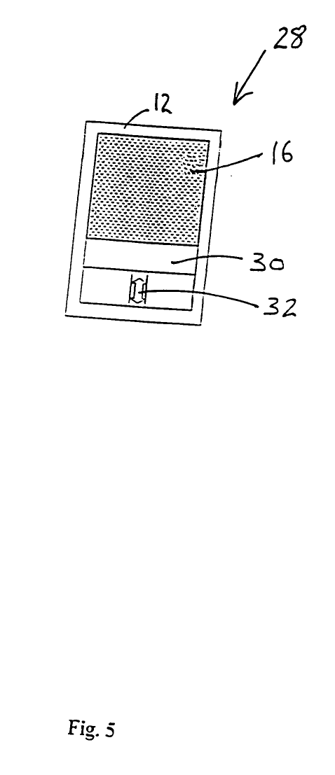

FIG. 5 shows a third particle vibration damper 28, again with a container 12 in which a plurality of particles 16 are located. A divider in the form of a piston 30 is provided extending across a lower part of the container 12, and the piston 30 can be moved in a vertical direction as required to vary the volume within the container 12 in which the particles are located. The piston 30 may be movable by a linear motor or piezoelectric actuator 32. This arrangement allows static, low or high frequency performance, and the size of the volume that locates the particles 16 can be chosen to provide peak damping ability at a required amplitude.

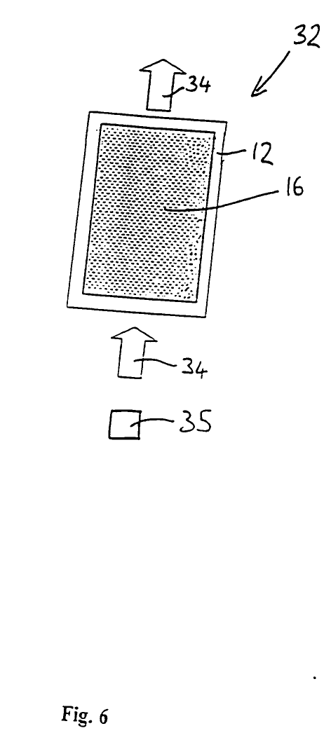

FIG. 6 shows a fourth particle vibration damper 32 with a container 12 which locates a plurality of particles 16. The container 12 is arranged such that a flow of air as shown by the arrows 34 can pass upwardly through the container from a fan 35. This air flow lifts the particles 16 thereby reducing pressure. This air bed arrangement is suitable for low amplitude excitation.

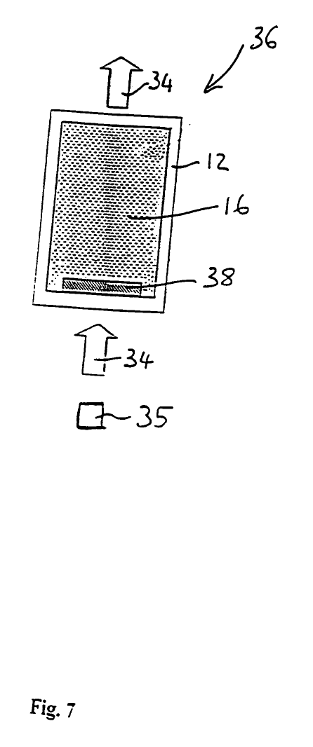

FIG. 7 shows a fifth particle vibration damper 36 which is similar to the particle vibration damper 32 except that a magnet 38 is provided at the base of the interior of the container 12. The magnet 38 may be a permanent magnet or could be an adjustable electromagnet which can be controlled as required. The magnet 38 provides an initial high level of contact between the particles 16. As the air flow is increased, the particles 16 fluidise, reducing the amplitude at which peak damping occurs.

There are thus described a number of different particle vibration dampers which all permit the amplitude at which peak damping occurs to be varied such that this can be matched to the vibration amplitude which is to be damped. All of the arrangements are of straightforward construction and can thus be inexpensively and robustly manufactured for substantially maintenance free operation.

Various modifications may be made without departing from the scope of the invention. For instance, two or more of the features described above can be combined in a damper. The shape of the damper could take a different form.

Whilst endeavouring in the foregoing specification to draw attention to those features of the invention believed to be of particular importance it should be understood that the other modifications may be made without departing from the inventive concept of the present invention.

We claim:

1. A particle vibration damper for damping the vibrations of a vibratory component., the damper including a body which defines a chamber in the interior thereof, a plurality of particles located in the chamber to a volume fill in excess of 90%, characterised in that the body also includes adjustment means for adjusting the inter-particle pressure and/or inter-particle forces of said particles to maintain the peak damping ability of the damper at the amplitude of the vibrations of the vibratory component.

2. A particle vibration damper according to claim 1, characterised in that the adjustment means produces an oscillating inter-particle pressure and/or inter-particle force.

3. A particle vibration damper according to claim 1, characterised in that the particles are magnetic and the adjustment means includes magnetic means for inducing a magnetic field in the chamber.

4. A particle vibration damper according to claim 3, characterised in that the magnetic means includes a coil extending around the chamber through which an electric current can be passed to provide the required magnetic field.

5. A particle vibration damper according to claim 4, characterised in that the voltage across the coil oscillates, and may oscillate at a frequency of less than 10 Hz.

6. A particle vibration damper according to claim 3, characterised in that the magnetic means includes a magnet located in the chamber, which magnet may be a permanent magnet or an adjustable electro magnet.

7. A particle vibration damper according to claim 1, characterised in that the adjustment means includes a member of variable size located in the chamber to enable adjustment of the inter-particle pressure.

8. A particle vibration damper according to claim 7, characterised in that the variable size member is in the form of an inflatable member, with means for selectively supplying a required amount of fluid into the inflatable member.

9. A particle vibration damper according to claim 1, characterised in that the adjustment means includes means for adjusting the size of the chamber.

10. A particle vibration damper according to claim 9, characterised in that the size adjustment means includes a divider extending across the interior of the body, and means for selectively moving the divider within the body.

11. A particle vibration damper according to claim 1, characterised in that the adjustment means includes means for passing a fluid through the chamber, and the fluid may be air.

12. A particle vibration damper according to claim 11, characterised in that the fluid passing means is arranged to provide an upward flow of fluid.

13. A particle vibration damper according to claim 1, characterised in that the chamber comprises particles to a volume fill of 95%.

14. A method of damping vibrations, the method including providing a particle damper with a plurality of particles within a chamber, wherein the chamber is filled with the particles to a volume fill in excess of 90%; characterised in that the method also includes adjusting the peak damping ability of the damper to substantially correspond to the amplitude of the vibrations.
